(19) United States
(12) Patent Application Publication
(10) Pub. No.: US 2025/0379246 A1
(43) Pub. Date: Dec. 11, 2025

(54) METHODS FOR CONTAMINANT REMOVAL FROM POLYMER ELECTROLYTE MEMBRANE FUEL CELLS AND FUEL CELL STACKS

(71) Applicant: Robert Bosch GmbH, Stuttgart (DE)

(72) Inventors: Jonathan Braaten, Sunnyvale, CA (US); Nathan Craig, Sunnyvale, CA (US)

(21) Appl. No.: 18/735,399

(22) Filed: Jun. 6, 2024

(51) Int. Cl. H01M 8/0662; H01M 8/1018

(52) U.S. Cl. CPC H01M 8/0662; H01M 8/1018

(57) ABSTRACT

Methods for removing contaminants from a polymer electrolyte membrane (PEM) fuel cell or fuel cell stack are provided. The methods are conducted without the need for disassembly of the cell or stack, and can be performed as throughout the lifetime of the cell or stack for prevention of performance loss. The methods include introducing an acidic solution to a first electrode side of a membrane electrode assembly and hydrogen gas to a second electrode side of the membrane electrode assembly and applying a hydrogen pumping current across. Thereafter, the acidic solution is removed by supplying reactant gases to the electrodes at relative humidity above saturation.

### TECHNICAL FIELD

The present disclosure relates to electrochemical cells and more particularly to proton-exchange membrane fuel cells (PEMFCs), and methods of removing contaminants therefrom.

### BACKGROUND

Proton-exchange membrane fuel cells (PEMFC), also known as polymer electrolyte membrane (PEM) fuel cells, are currently the leading technology for transport vehicles. PEM fuel cells are often preferred because they can operate at temperatures and pressures lower than other types of fuel cells. A PEM fuel cell typically includes a water-based, acidic polymer membrane as its electrolyte. This membrane, which is also commonly referred to as an ionomer, has electrodes disposed on either side, an anode layer and a cathode layer. The combination of the anode layer-membrane-cathode layer is considered the membrane electrode assembly (MEA) of a fuel cell. The anode and cathode layers are commonly formed from platinum-based catalysts, including platinum alloys.

During operation of a fuel cell hydrogen gas (H₂) is supplied at the anode side and when the H₂ gas contacts surface of the platinum-based catalyst layer, the gas undergoes a hydrogen oxidation reaction wherein the gas is dissociated into electrons and protons. The protons pass through the membrane to the cathode side of the MEA (the membrane is selective in that only the protons are able to pass through to the cathode side) while the released electrons travel in an external circuit, thus generating the electrical output of the cell. On the cathode side, air or oxygen gas is supplied. The protons which have passed through the ionomer membrane combine with oxygen molecules at the cathode catalyst layer, which undergo an oxygen reduction reaction. This produces water molecules which are then expelled from the cathode side of the fuel cell as the only waste product. Oxygen can be provided to the cathode side either in pure form or extracted at the electrode directly from air.

Platinum is a preferred precious metal for cathode and anode catalyst layers because it is recognized for boosting catalytic activity, increasing the rate of an oxygen reduction reaction and reducing kinetic overpotentials associated with PEM fuel cells. The use of alloys in the platinum layers has led to improvements in PEMFC performance and also reduction in the necessary mass of platinum, i.e. platinum loading. However, the incorporation of alloys also has drawbacks, particularly after long operation, when cations from the alloying elements, for example cobalt and nickel cations, can leach out of the platinum catalyst layer and contaminate other components of the fuel cell. These contaminant cations can diffuse and be trapped in the ionomer (the polymer membrane) and in the electrode layers of the MEA. Once the membrane and electrodes are contaminated with these cations, this severely impacts the transport of the reactant species within the MEA, i.e. the protons from H₂ supplied to the anode side and molecular oxygen supplied to the cathode side, which in turns interferes with the effective operation of the MEA and results in permanent performance loss of the fuel cell. This results in reduced lifetime of a PEM fuel cell or fuel cell stack.

In addition to contaminant contributions due to cation leaching from the platinum catalyst layers, other types of contaminant cations can be introduced to an operating PEM fuel cell from the outside environment. For example, calcium and sodium from salts in water and/or from compositions used on road surfaces for de-icing can be deposited on the fuel cells and become act as contaminants as well. These cations are also undesirable and cause significant performance losses of the fuel cells. Thus, the combination of contaminant cations from environmental sources and from the degradation of the MEA layers ultimately leads to a reduced lifetime of the PEM fuel cell or fuel cell stack. Hence there is a need for maintenance protocols for PEM fuel cells which can routinely be used to eliminate cation contaminant buildup within the MEAs.

More particularly, there exists a need for a method of cation contaminant removal which can be conducted on a single cell or a stack assembly, without the need to disassemble the stack, or remove it from the vehicle, i.e. an in-situ method of cation contaminant removal. Further, there exists a need for contaminant removal which does not use harsh acidic formulations and does not degrade existing elements and components of the cells. Additionally, there remains a need for a maintenance protocol which can be used on intact fuel cells and stacks throughout the life of the fuel cells, to reduce or prevent performance/voltage losses and increase the life span of the fuel cell or fuel cell stack.

### SUMMARY

Disclosed herein are methods of contaminant removal from PEM fuel cells. Also disclosed are methods for preventing or reducing performance losses and voltage losses in a fuel cell or stack.

In one embodiment of the present disclosure, a method of removing contaminants from a polymer exchange membrane fuel cell or fuel cell stack is provided. The method incorporates various steps which are designed to concentrate cation contaminants on a specific side of a membrane electrode assembly (MEA), and remove those contaminants therefrom, without the necessity to remove the fuel cell or stack from its assembly within a vehicle, and without disassembly of the multitude of cells within a stack. Hence, the methods described herein are advantageous in that stack disassembly is not required and the contaminant removal can be performed in-situ at various stages of the lifetime of an installed fuel cell.

In an embodiment, a method of contaminants removal from a PEM cell includes:
introducing an acidic solution to a first electrode side of a membrane electrode assembly and hydrogen gas to a second electrode side of the membrane electrode assembly; and
applying a hydrogen pumping current across the membrane electrode assembly.
   Contaminants are concentrated on the first electrode side, and are removed from the first electrode side by contact with the acidic solution.

The contaminants which are removed from the membrane and various other components of the fuel cell, include cation contaminants originating from cell components and also external pollutants, such as for example nickel, cobalt, iron, calcium, sodium, potassium, magnesium, barium, aluminum, chromium, or a combination thereof.

In a further embodiment, once the above described acid flushing step has been conducted on at least one electrode side of the cell, a water flushing step is performed to remove remnant acidic solution within the various components of the cell on the side where the acidic solution was provided in the preceding step. This step comprises flushing the second electrode side with de-ionized water and thereafter supplying reactant gases at relative humidity above saturation to the first electrode side and the second electrode side, while applying a hydrogen pumping current across the membrane electrode assembly. The reactant gas supplied to the first electrode side is an oxygen source (O₂ or air), while the gas supplied to the second electrode is hydrogen. During this step, the oxygen or air stream supplied to the first electrode side reacts with reformed hydrogen at the first electrode to produce water molecules which flush out remaining acidic solution on the first electrode side.

The supply of reactant gases in this embodiment is set to relative humidity (RH) values above saturation, meaning that the gases (O₂ and H₂) are supplied to their respective electrodes in a saturated or even super saturated state, having relative humidity value (RH) greater or preferably greater than 150%. Using increased humidity levels for the inlet reactant gas streams (H₂ and O₂) at their respective electrodes sides will provide stack conditions that can generate water within the fuel cells to flush away any remnant contaminants and remaining acidic solution, within the GDLs, the flow fields or channels of the bipolar plates, and the surface of the respective electrodes.

In an additional embodiment, once the acid flushing and water flushing procedures are completed, a dry out phase can optionally be conducted on the cell or stack. During this step dry reactant gases are supplied to the first electrode side and second electrode side, after contaminants have been removed either from the acid flushing step, or following the combination of acid flushing and water flushing steps. The dry gases have a relative humidity (RH) value of about 50% or less.

In another embodiment, a method of in-situ performance loss prevention for polymer electrolyte membrane fuel cell or fuel cell stack is provided. It is well understood by those skilled in the art that the leaching of contaminant ions and other external pollutant species which deposit on cell components contribute to a significant voltage loss of the cell, and reduced lifetime of a cell. Hence periodic removal of said contaminants is a means for the prevention of performance loss and voltage loss of a cell. Therefore, in one embodiment, an in-situ cell performance loss prevention method comprises the steps of:
a) introducing an acidic solution to a cathode side of a membrane electrode assembly and hydrogen gas to a anode side of the membrane electrode assembly; and applying a hydrogen pumping current across the membrane electrode assembly;
b) supplying reactant gases at relative humidities above saturation to the cathode side and the anode side; and
c) providing dry reactant gases to the cathode side and anode after contaminants are removed;
d) optionally conducting steps a) through c) for an opposite side of the membrane electrode assembly, wherein in step a) the acidic solution is introduced to the anode side and the hydrogen to the cathode side, and a reversed hydrogen pumping current is applied across the membrane electrode assembly.

The above described features and additional embodiments will be described in detail in the sections that follow and are exemplified by the following figures and detailed description.

### Selected Definitions

As used herein, the term “contaminants” refers to contaminant species which originate from fuel cell components, such as for example from electrode catalyst materials, but have been leached from those components and potentially migrated to other components within the fuel cell or stack. The term “contaminant” also can include contaminant materials which originate externally from the cell, such as external pollutants deposited on cell components from an external source.

As used herein, the term “in-situ” can refer to an onsite position, or in an original position, or an existing assembled position of a component, meaning that if a step is performed “in-situ” with respect to a component, it is being carried out while a component is in its original place, or original assembled position and configuration. That component does not need to removed or disassembled from that location or position, for that step to be carried out.

As used herein, the term “reactant gases” refers to gaseous species which are commonly supplied to both electrodes of a PEM fuel cell, the cathode and the anode. Thus, the term includes hydrogen source gases and oxygen source gases. Hydrogen source gases can include molecular hydrogen itself (H₂), methane gas (CH4) and oxygen source gases include molecular Oxygen (O₂) and air.

As used herein the term “first electrode” and “second electrode” are electrochemically agnostic and interchangeable, meaning that either term can be used to refer to either to the cathode or the anode electrodes of a PEM fuel cell.

As used herein the term “relative humidity” or “RH value” refers to is the amount of water vapor present in the gas compared to the amount that could be present in the gas at the same temperature, and is expressed in percent (%) form. The term “saturation” refers to the maximum amount of water vapor in a gas at an existing temperature and pressure. For example, air is said to be saturated at 100% relative humidity when it contains the maximum amount of moisture possible at that specific temperature and pressure. As used herein, the term “above saturation” will refer to gases that have a RH value greater than 100%.

For purposes of this disclosure, the terms “proton exchange membrane”, “PEM”, “the membrane”, or “the ionomer” can be used interchangeably and refer to the same structure within a fuel cell.

As used herein, “Molar” or “M” or “mol/L” and variations thereof refer to the unit of concentration molarity, which is equal to the number of moles of solute dissolved in one liter of solution.

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### BRIEF DESCRIPTION OF THE DRAWINGS

FIG. 1 is a cross-sectional schematic of a PEM fuel cell showing the input and output reactant gas flows and the proton and electron transport and pathways during normal operation of said fuel cell.

FIG. 2 is a cross-sectional view of a PEM fuel cell, showing proton and contaminant cation exchange and transport on a first electrode side of the cell, according to an embodiment of the present disclosure.

FIG. 3 is a cross-sectional view of a PEM fuel cell, showing proton and contaminant cation exchange and transport on an opposite, second electrodes side of the cell, according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Methods for removing contaminant cations from a fuel cell or a fuel cell stack are disclosed herein. The methods are performed without disassembly of the fuel cell or stack and without removal of the fuel cell or stack from a vehicle wherein it is housed.

A fuel cell stack comprises a plurality of individual fuel cells that preferably include flow field support structures disposed in the flow fields at opposing sides of a membrane electrode assembly (MEA) defined by a membrane and electrodes. The electrodes provide reactive sites for the dissociation of hydrogen gas into protons and electrons and the subsequent combination of the protons and the electrons with oxygen to form water. The hydrogen gas fed to the fuel cell may be received from any hydrogen source including, but not limited to, a hydrocarbon, natural gas, or the like. At least one of the electrodes may comprise a porous catalytic structure that structurally supports the cell components. The flow field support structures may be screen packs, bipolar plates, porous members, and/or similar structures that are disposed within the flow fields such that the MEA is sufficiently supported. Alternately, the flow field support structures may comprise screen packs, bipolar plates, and/or porous membranes having an electrode incorporated directly therein.

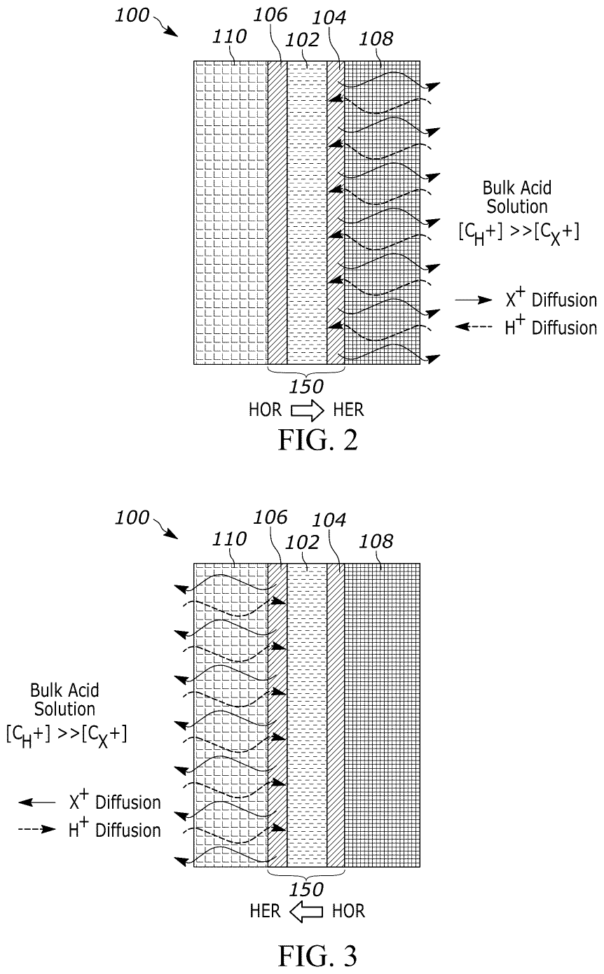

An exemplary embodiment of a fuel cell is shown in FIG. 2, which depicts a cross sectional view of a PEM fuel cell 100. A stack, into which fuel cell 100 is incorporated, preferably includes a plurality of cells 100 employed as part of the cell system. For example, a typical fuel cell stack used in a vehicle may have two hundred or more stacked fuel cells. For brevity and case of reference, the fuel cell 100 will be described in an individual context referencing its individual components, but it is to be understood that these descriptions and functions pertain to all individual fuel cells 100 within a fuel cell stack. Fuel cell 100 comprises a membrane electrode assembly (MEA) 150. The MEA 150 includes a central proton exchange membrane 102 and a pair of electrodes disposed on each side of the membrane 102. For purposes of this disclosure, “proton exchange membrane”, “PEM”, “the membrane”, or “the ionomer” can be used interchangeably and refer to the same structure, 102. The pair of electrodes are more specifically referenced to as a first electrode 104 and a second electrode 106. In the embodiment shown in FIG. 2, it is to be understood that first electrode 104 refers to a cathode, and the second electrode 106 refers to an anode. The first electrode 104 is disposed next to a first gas diffusion layer (GDL) 108. Similarly, the second electrode 106 is disposed next to a second gas diffusion layer 110.

A fuel cell 100 would incorporate flow field structures, also known as bipolar plates, disposed at each side and in contact with the first and second gas diffusion layers 108 and 110 (not shown in FIG. 2). The bipolar plates have specific machined flow channels that allow for the even distribution and flow of the reactant gases entering the cell to pass through the GDLs and reach the electrodes of the MEA, for the required reactions and ion exchange to take place. Bipolar plates have dual functions-they guide the flow of fluid or reactant gases through the cell and are also made of conductive material and conduct electrical current from one cell to the next. Optionally, collector plates (not shown) can also be present and in operable communication with the bipolar plates at each opposing side of the MEA 150. Collector plates facilitate the collection of electrical charge within fuel cell 100 and connects the fuel cell to an external load.

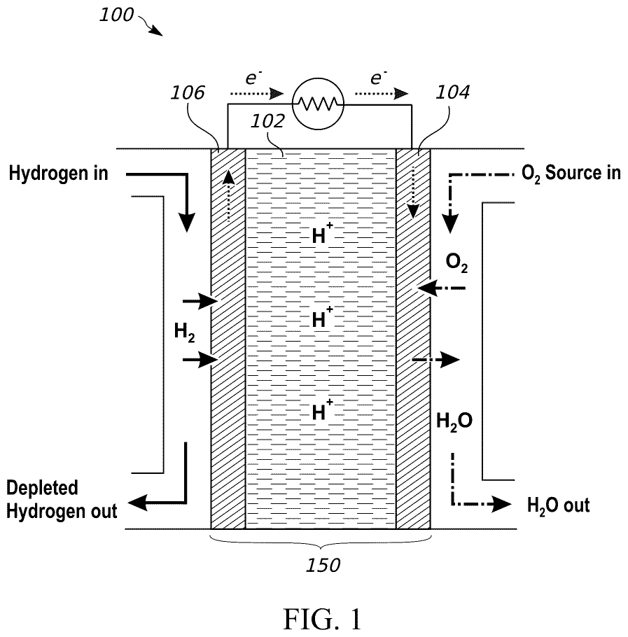

As can be seen in FIG. 1, during normal operation of a fuel cell 100, hydrogen gas (H₂) would be supplied to the anode side of the cell, and an oxygen source (O₂ or Air) would be supplied to the cathode side. The hydrogen gas passes through the anode side gas diffusion layer (not shown) reaches the anode side electrode, at which point it is dissociated to generate free protons and electrons. The protons pass through the proton exchange membrane (ionomer) 102 to the cathode, while the electrons from the anode cannot pass through the ionomer, and thus are directed through an electrically connected external load to perform work, before being sent to the cathode. The protons that pass through the membrane 102 and reach the cathode side then react with the oxygen and the electrons at cathode electrode to generate water. Hence water is generated at the cathode side and is the primary byproduct or effluent outlet product of the process, and is carried out of the cathode side of the cell via an effluent outlet means.

The proton exchange membrane 102 is typically formed of a polymer and functions as an electrolyte. Membrane 102 can comprise electrolytes that are preferably solids under the operating conditions of the electrochemical cell. Useful materials from which the membrane 102 is commonly fabricated include proton conducting ionomers and ion exchange resins. Useful proton conducting ionomers include complexes comprising an alkali metal salt, an alkali earth metal salt, a protonic acid, a protonic acid salt, or the like, as well as combinations of the foregoing materials. Counter-ions useful in the above salts include halogen ion, perchloric ion, thiocyanate ion, trifluoromethane sulfonic ion, borofluoric ion, and the like, as well as combinations of the foregoing materials. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like, as well as combinations of the foregoing materials. The alkali metal salt, alkali earth metal salt, protonic acid, or protonic acid salt is complexed with one or more polar polymers such as a polyether, polyester, or polyimide, or with a network or cross-linked polymer containing the above polar polymer or combination of polymers as a segment. Useful polyethers include polyoxyalkylenes, such as polyethylene glycol, polyethylene glycol monocther, and polyethylene glycol diether; copolymers of at least one of these polyethers, such as poly(oxyethylene-co-oxypropylene)glycol, poly(oxyethylene-co-oxypropylene) glycol monoether, and poly(oxyethylene-co-oxypropylene)glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid, are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

According to one embodiment, the membrane 102 is a fluorocarbon-type ion-exchange resin, namely a polytetrafluoroethylene (PTFE)-based ionomer. Fluorocarbon-type ion-exchange resins include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids, and bases. One family of fluorocarbon-type resins having sulfonic acid group functionality is NAFION@ resins (commercially available from E. I. du Pont de Nemours and Company, Wilmington, Del.).

The first and second gas diffusion layer (GDL) 108 and 110, respectively, are the cell components which are primarily responsible for the gas and water transport in cell 100. GDLs typically consists of two main layers which are the macroporous substrate and the microporous layer. The microporous layer faces the electrode catalyst layer and it generally works by providing gas diffusion through carbon paper or carbon cloth and collecting the current. Carbon-based materials are commonly used and preferred for the fabrication of GDLs. Carbon is a favorable material that is capable of providing good electrical conductivity, gas permeability, elasticity and durability for PEM fuel cell components.

The first electrode 104 and second electrode 106 are typically formed from catalytic materials suitable for performing the required electrochemical reactions (e.g., the dissociation of hydrogen gas). Suitable catalytic materials for first and second electrodes 104 and 106 include, but are not limited to, platinum, palladium, rhodium, carbon, gold, tantalum, tungsten, ruthenium, iridium, osmium, alloys thereof, and the like, as well as combinations of the foregoing materials. In one embodiment, the first electrode 104 and second electrode 106 are comprised of a platinum alloy material. The platinum alloy can include PtFe, PtCo, PtNi, or other known platinum alloys that are commonly used for PEM fuel cells and are well known in the art. Platinum alloys are used as the catalyst for both the hydrogen oxidation reaction (HOR) occurring at the anode and the oxygen reduction reaction (ORR) at the cathode. The platinum catalyst takes the form of small particles deposited on the surface of larger carbon particles that act as a porous carbon support substrate. To form the first electrode 104 and second electrode 106, adsorption of the catalytic platinum particles onto the carbon substrate may be achieved by any method including, but not limited to, spraying, dipping, painting, imbibing, vapor deposition, or combinations of the foregoing methods. For example, a platinum/cobalt (PtCo) electrode catalysts are typically prepared by co-depositing or sequentially depositing platinum and cobalt from salt solutions onto the carbon support substrate, followed by annealing at high temperature (about 900° C.) to obtain the alloy form.

Use of an alloy is advantageous because it allows for less platinum loading, which in turn lowers the overall cost associated with the PEM fuel cell. However, as previously discussed, use of alloying metals does have its drawbacks, such as for example when the alloy cations leach from the catalyst layer and migrate to other components of the cell, including the gas diffusion layers, 108, 110 and the membrane 102. The component degradation and cell voltage loss which results from this cation contamination effects the immediate performance of the cell and also its overall lifespan. Thus there is increased need for methods and protocols of cation contaminant removal from a PEM cells, so that the cell stack can maintain its automotive performance target over the expected lifetime of the vehicle.

In one embodiment of the present disclosure, a method of removing contaminants from a polymer exchange membrane fuel cell or fuel cell stack is provided. The method incorporates various steps which are designed to concentrate cation contaminants on a specific side of an MEA 150, and remove those contaminants therefrom, without the necessity to remove the fuel cell or stack from its assembly within a vehicle, and without disassembly of the multitude of cells within a stack. Hence, the methods described herein are advantageous in that stack disassembly is not required and the contaminant removal can be performed in-situ at various stages of the lifetime of an installed fuel cell.

The methods described herein include a combination of at least two different procedures, not all of which are required for contaminant removal, but the procedures, when carried out in combination result in optimal contaminant removal. First an acid flushing step is performed which is used to concentrate and remove cation contaminants from the electrode where the acid solution is being supplied. Once the cation contaminants are removed from this electrode, then an optional water flushing step is performed on the same electrode where the acid solution was used in the previous step. The purpose of the water flushing step is to remove any remnant acid solution species that may reside in the fuel cell components. Once the water flushing step is completed, then dry reactant gases are supplied to the electrodes to dry out the electrode components and remove any remnant water content, and to prepare the cell for its normal operation. While it is preferred that all three steps be undertaken to remove contaminants and return the cell to normal operation, it will be understood by those skilled in the art that some steps are optional and a combination of the above steps can be performed, while others can be omitted. Each of the various procedures listed above will be described in detail in portions of the disclosure that follow.

Using the depiction of the fuel cell 100, shown in FIG. 2, a method of contaminants removal will now be described. The method includes:
introducing an acidic solution to a first electrode 104 side of a membrane electrode assembly 150 and hydrogen gas to a second electrode 106 side of the membrane electrode assembly 150; and
applying a hydrogen pumping current across the membrane electrode assembly 150.
   Contaminants are concentrated on the first electrode 104 side, and are removed from the first electrode 104 side by contact with the acidic solution. The concentration of contaminants on the first electrode 104 side happens partly because of the proton and contaminant chemical exchange fluxes that are driven by the flow of the acidic solution, and also because of the hydrogen pumping current which assist in displacing trapped contaminants within the membrane 102.

The contaminants are cations originating from leached electrode materials, or cations from external pollutants, or a combination thereof. In the embodiment, a weak aqueous acidic solution is employed and supplied to the first electrode 104, while hydrogen gas is supplied to the opposing electrode side, the second electrode (106). In this particular example shown in FIG. 2, the first electrode 104 is the cathode of the cell 100 and the second electrode 106 is the anode. While the weak acidic solution is supplied to the first electrode 104 side, a hydrogen pumping current is applied across the MEA 150. That is to say, a direct current is applied across the membrane 102 to “pump” hydrogen protons through the membrane 102. During the application of the current across membrane 102, hydrogen gas at the anode will ionize, enabling hydrogen ions (protons) to transfer through the membrane 102 from anode (second electrode 106) to the cathode (first electrode 104) while the electrons pass through an external power source (not shown) to the cathode. This hydrogen pumping current polarizes the membrane 102 and this polarization causes the migration of contaminant cations within the membrane 102 to the reducing electrode, in this example, the first electrode 104, thereby enabling more efficient removal with the acidic solution.

While not intending to be bound by theory, it is believed that use of the acidic solution flowing through the first electrode side 104 will establish a chemical potential difference between the acidic solution and the ionomer membrane 102, driving fluxes of protons into the ionomer, where they will displace contaminant cations and drive fluxes of contaminant cations out membrane 102, effectively purifying the membrane. As seen in FIG. 2, dashed lines and arrows refer to diffusion of protons from the acidic solution towards the first GDL 108 and then the first electrode 104, where they are then absorbed into membrane 102. The solid lines with arrows refer to the contaminant cations released from membrane 102 and the first electrode 104. The acidic solution thereby provides a chemical driving force for cation desorption and proton absorption at the first electrode 104 side. Through the combinatorial use of the hydrogen pumping current and the chemical potential established between the acidic solution and the membrane, any leached cations which are trapped in the membrane or the first electrode 104 are forced to migrate and become concentrated on the surface layer of the first electrode 104. They are then taken up by contact with the acidic solution which is flowing through the first GDL 108 to the first electrode 104 side. As the acidic solution exits the fuel cell 100 through an effluent outlet (not shown), so do the contaminant cations contained therein in the acidic solution effluent stream.

In FIG. 2, C_{H}+ refers to the concentration of hydrogen protons entering the first GLDL 108 and the first electrode 104 from the acidic solution and C_{X}+ refers to the concentration of the contaminant cations desorbed from the first electrode 104 side. The direction of the hydrogen pumping current is indicated in FIG. 1, with the hydrogen oxidation reaction (HOR) occurring at the second electrode 106 and the hydrogen evolution reaction (HER) occurring at the first electrode 104. Therefore, in this embodiment hydrogen is broken down at second electrode 106 (into protons and electrons) and once hydrogen protons travel through the membrane 102 to the first electrode 104, hydrogen gas (H₂) is then reformed at this first electrode 104. The output at the second electrode 104 side is then the reformed H₂ gas and the acidic solution flowing out. The magnitude of the hydrogen pumping current should be controlled, such that hydrogen bubble formation in the fuel cell cathode side is suppressed to prevent structural damage to that electrode.

The hydrogen pumping current is conducted in an oxygen free or oxygen depleted environment and conditions. This means that there is no reactant oxygen gas being supplied to the cathode side during this step (as would be typically the case during normal operation of a fuel cell). Prior to the acidic solution being introduced at the first electrode 104 side, oxygen containing reactant gas (O₂ or air) is pumped to the cathode side (104), while hydrogen is pumped to the anode side (106). A direct current is applied to polarize the MEA 150, which then turns the supplied oxygen gas into water. The supply of the oxygen gas is followed by the supply of acidic solution. As the remaining oxygen is reacted to form water at the cathode side, followed by the acidic solution flow, no more oxygen remains in the system and the hydrogen pumping current is initiated (as described in detail in the first embodiment). Hence, this step occurs in an oxygen free or oxygen depleted configuration.

It is to be understood that the same acidic solution flushing step as described in the above embodiment can also be conducted on the opposite electrode, as shown in the schematic of FIG. 3. In this embodiment, the hydrogen pumping current is reversed, and the acidic solution is instead supplied at the second electrode 106 side, (the anode) while the hydrogen gas is supplied to the first electrode 104 side (the cathode). The application of a reverse hydrogen pumping current, will polarize the membrane 102, in an opposite direction than in the first embodiment, and will then cause displacement, migration and a concentration of cation contaminants towards the surface of the second electrode 106 side. The concentrated cations will then be taken up and removed by contact with the flowing acidic solution that is being supplied to the second electrode 106 side. This reverse configuration will of course mean that the HOR and HER reactions are also reversed, with the hydrogen oxidation reaction (HOR) occurring at the first electrode 104 and the hydrogen evolution reaction (HER) occurring at the second electrode 106.

Therefore, in one embodiment, the method of contaminant removal further includes the additional step of:
introducing the acidic solution to the second electrode 106 side and hydrogen gas to the first electrode 104 side; and
applying a reversed hydrogen pumping current across the membrane electrode assembly 150.
   This results in contaminants being concentrated on the second electrode 106 side, whereby the contaminants are removed from the second electrode 106 side by contact with the acidic solution flowing to this side.

It is a preferred embodiment that the cation contaminant species be removed from each side of the cell 100, i.e. from both the cathode and anode side, although in theory, one could conduct the acidic flushing process on only one electrode side of the cell 100, either the anode or the cathode side, prior to proceeding to other optional steps in the contaminant removal methods disclosed herein. The order of which electrode side is processed first is not of particular importance. Hence, in the first embodiment described in this disclosure, the first electrode 104 side could refer to the anode, and the second electrode 106 side could refer to the cathode, or vice versa.

The acidic solution employed for the above described steps is preferably a weak aqueous acidic solution. Using a weak acidic solution ensures protection of the various components of the cell 100, such as the gas diffusion layers, 108, 110, the electrode layers 104, 106 and the membrane 102, although in theory the acidic solution will not directly reach the membrane 102. A weak acidic solution will not cause degradation or corrosion of these components and will not interfere with their compositional and structural integrity. In one embodiment, the acidic solution employed has a molarity in the range of about 0.05 M to about 1.0 M. or about 0.1 M to about 0.9 M, or about 0.2 M to about 0.8 M, about 0. M to about 0.7 M, about 0.4 M to about 0.6 M, or about 0.5 M, or any molarity value therein.

In embodiments, the acidic solution can include nitric acid as a singular acidic species, or as one source in a combination of acids. Other known acids suitable for purposes of this disclosure include, hydrochloric acid, sulfuric acid, hydrobromic acid, hydroiodic acid, perchloric acid, chloric acid, and/or a combination thereof. It will be understood by those skilled in the art, that other additional acidic solutions may be employed for this step, as long as they are used in low molar concentrations so that they will not cause degradation or corrosion of the fuel cell 100 components.

In one embodiment, the acidic solution is supplied at a constant rate over a period of time ranging from about 10 minutes to about 2 hours. This step should be conducted in an appropriate duration until there are no detectable contaminants present in the acid solution effluent stream exiting the first electrode 104 side (or second electrode 106 side). Once a steady-state of low contaminant cation concentration is reached in the acidic effluent stream, or when there are no detectable cations in the effluent stream, the supply of acidic solution can be terminated, as this would indicate that most of the contaminant cation species have been removed. As the diffusion of cation contaminant species through the various fuel cell components can be rather slow, the acid flushing step may need to be executed for a long period of time, including for example several hours. In one embodiment, the acid flushing step is conducted for a period of about 20 min to 1.5 hours, or about 30 min to about 1.2 hours, or about 40 min to about 1 hour, or any time value therein.

The acidic solution is supplied at a constant rate ranging from 10 ml/min per cm³ to 100 ml/min per cm³. By supplying the solution at constant rate, one can prevent the buildup of contaminant cations and prevent proton depletion of the membrane 102. In one embodiment, the acidic solution is supplied at a constant rate ranging from 20 to 80 ml/min per cm³, or from 30 to 70 ml/min per cm³, or from 40 to 60 ml/min per cm³, or any value therein. In one embodiment, the acidic solution provided to the cell 100 can be heated, for example to a temperature range of about 40° C. to about 100° C., or about 50° C. to about 90° C., or about 60° C. to about 80° C. It is believed that providing the acidic solution at an increased temperature, within the disclosed ranges, can increase cation exchange and desorption from the membrane 102, the GDLs and the respective surface of the electrodes.

The cation contaminants which are removed from the membrane 102 and various other components of the fuel cell 100, include cation contaminants originating from cell components and external pollutants, such as for example nickel, cobalt, iron, calcium, sodium, potassium, magnesium, barium, aluminum, chromium, or a combination thereof. These list of contaminants is not intended to be limiting, and other cation or pollutant species may be present, even in trace amounts, and be removable by the methods disclosed herein. Those of skill in the art will appreciate that other contaminant species other than those listed, may be present and removable from the fuel cell 100 through this acidic flushing process.

In a further embodiment, once the acid flushing step has been conducted on at least one electrode side of the cell 100, a water flushing step is performed to remove remnant acidic solution within the various components of the cell 100 on the side where the acidic solution was provided in the preceding step. This step comprises flushing the second electrode 104 side with de-ionized water and thereafter supplying reactant gases at relative humidities above saturation to the first electrode 104 side and the second electrode 106 side, while applying a hydrogen pumping current across the membrane electrode assembly 150. The reactant gas supplied to the first electrode 104 side is an oxygen source (O₂ or air), while the gas supplied to the second electrode 106, is hydrogen. During this step, the oxygen or air stream supplied to the first electrode 104 side reacts with reformed hydrogen at the first electrode 104 to produce water molecules which flush out remaining acidic solution on the first electrode 104 side. The reformed hydrogen is occurring due to the supply of hydrogen gas at the second electrode 106 side and the hydrogen pumping current across MEA 150, which breaks down hydrogen molecules at the anode side and once the protons pass the membrane 102, reforms the hydrogen molecules at the cathode side (104).

The supply of reactant gases in this embodiment is set to relative humidities (RH) values above saturation, meaning that the gases (O₂ and H₂) are supplied to their respective electrodes in a saturated or even super saturated state, having relative humidity value (RH) greater than 100%, or greater than 110%, or greater than 120%, or greater than 130%, or greater than 140%, or preferably greater than 150%.

Using increased humidity levels for the inlet reactant gas streams (H₂ and O₂) at their respective electrodes sides will provide stack conditions that can generate water within the fuel cells to flush away any remnant contaminants and remaining acidic solution, within the GDLs, the flow fields or channels of the bipolar plates, and the surface of the respective electrodes.

During this water flushing step, the fuel cell or stack will be operated at relatively low temperatures where significant condensation will result to generate liquid water in the cells. The desired cell temperature can be achieved by any suitable technique, such as flowing cooling fluid by a pump at a relatively high flow rate and at a low cell or stack power output. In one non-limiting embodiment, the temperature of the cell 100 can be set to be less than 60° C., and preferably less than 30° C. In this embodiment, the cell is be set to operate at a relatively low average cell voltage. In one non-limiting example, the average cell voltage should be less than about 500 mV, less than about 400 mV, and preferably less than 300 mV. The water flushing step is conducted for a duration of about 10 min to about 2 hours, or about 20 min to about 1.5 hours, or about 30 min to about 1.2 hours, or about 40 min to about 1 hour, or any time value therein.

The cell 100 or cell stack inlet increased relative humidity (RH) may be configured to be provided on the cathode side only or on the cathode side and anode side together. That is to say, both inlet streams of reactant gases (H₂ and O₂) are provided at humidity levels above saturation, or only the cathode side gas is provided at levels about saturation, while H₂ gas at the anode is provided under standard conditions.

It is to be understood that during the above described water flushing step, the cell 100 or stack is not operating under normal cell parameters, but rather this is a down phase where cell or stack it is undergoing maintenance protocols or servicing. This is similarly the case for the acid flushing step as well.

In an additional embodiment, once the acid flushing and water flushing procedures are completed, a dry out phase can optionally be conducted on the cell 100 or stack. During this step dry reactant gases are supplied to the first electrode 104 side and second electrode 106 side, after contaminants have been removed either from the acid flushing step, or following the combination of acid flushing and water flushing steps.

This dry out process is conducted so that remnant water remaining within the flow fields or channels, or GDLS or electrode surfaces can be removed, thusly readying the cell 100 or stack for normal operations. During this step, dry O₂ or air is provided to the first electrode side 104, and dry H₂ is provided to the second electrode 106. Dry gases refers to the relative humidity (RH) level that is commonly used for normal operation of the cell, i.e. RH values of about 50% or less, which are considered standard values for reactant gases inlet streams in PEM cells. This step is conducted for a duration that is necessary for the remnant water or acidic solution to be eliminated from the cell 100. In one embodiment, the dry gases are provided for a duration of about 10 min to about 2 hours, or about 20 min to about 1.5 hours, or about 30 min to about 1.2 hours, or about 40 min to about 1 hour, or any time value or range therein. Once the cell or stack no longer has excess or trapped moisture/water content (e.g., water bubbles within flow fields), it is then ready to return to normal operating parameters and conditions.

According to another embodiment, a method of removing contaminants from a polymer electrolyte membrane fuel cell or fuel cell stack is disclosed. The method includes the following steps:
introducing an acidic solution to a first electrode side and hydrogen gas to a second electrode side of a membrane electrode assembly and applying a hydrogen pumping current across the membrane electrode assembly;
introducing the acidic solution to a second electrode side and hydrogen gas to a first electrode side of the membrane electrode assembly and applying a reverse hydrogen pumping current across the membrane electrode assembly;
optionally removing remnant acidic solution from either the first electrode side or second electrode side by supplying reactant gases at relative humidities above saturation to the first electrode side and second electrode side; and
optionally supplying dry reactant gases to the first electrode side and second electrode side.

In an additional embodiment, a method of in-situ performance loss prevention for polymer electrolyte membrane fuel cell or fuel cell stack is provided. It is well understood by those skilled in the art that the leaching of contaminant ions and other external pollutant species which deposit on cell components contribute to a significant voltage loss of the cell, and reduced lifetime of a cell. This is because the available areas on the catalyst electrode surfaces for the required electrochemical reactions are negatively impacted by leached and/or deposited foreign cations. The performance of the ionomer membrane is also significantly impacted, as the proton travel pathways are interrupted due to cation species migrating within the polymer matrix of the membranes. Hence periodic removal of said contaminants is a means for the prevention of performance loss and voltage loss of a cell. Therefore, in one embodiment, an in-situ cell performance loss prevention method comprises the steps of:
a) introducing an acidic solution to a cathode side of a membrane electrode assembly and hydrogen gas to a anode side of the membrane electrode assembly; and applying a hydrogen pumping current across the membrane electrode assembly;
b) supplying reactant gases at relative humidities above saturation to the cathode side and the anode side; and
c) providing dry reactant gases to the cathode side and anode after contaminants are removed;
d) optionally conducting steps a) through c) for an opposite side of the membrane electrode assembly, wherein in step a) the acidic solution is introduced to the anode side and the hydrogen to the cathode side, and a reversed hydrogen pumping current is applied across the membrane electrode assembly.

As is evident from the various embodiments described herein, the various method steps can be achieved and performed in different configuration of sequential step. For example in one embodiment, only the acidic solution step for contaminant removal on one side of the fuel cell is performed. In another embodiment the acidic flushing process is conducted on both sides of the fuel cell (i.e. to decontaminate both electrode sides).

In another embodiment, the acid flushing step is performed on the cathode side, then a water flushing step is performed on the same side, followed by supply of the dry gas on the same side. This process is then repeated again on the opposing side of the MEA. So if the first procedure is performed on the cathode side, then all three steps can then be repeated on the anode side, keeping in mind that the hydrogen pumping current would have to be reversed to polarize the MEA in the opposite direction.

In another embodiment, only the acid flushing and water flushing steps are performed. In a further embodiment, only the acid flushing and dry gas steps are performed. In another embodiment, the acidic solution flushing step is conducted on both the cathode and anode first, followed by the water flushing on the cathode, then anode side, followed by the dry gas steps.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of removing contaminants from a polymer electrolyte membrane fuel cell or fuel cell stack, comprising:
introducing an acidic solution to a first electrode side of a membrane electrode assembly and hydrogen gas to a second electrode side of the membrane electrode assembly; and
applying a hydrogen pumping current across the membrane electrode assembly;
wherein the contaminants are concentrated on the first electrode side, and
wherein the contaminants are removed from the first electrode side by contact with the acidic solution.

2. The method of claim 1, wherein the contaminants are cations originating from electrode materials or external pollutants, or a combination thereof.

3. The method of claim 1, further comprising:
supplying reactant gases at relative humidity above saturation to the first electrode side and the second electrode side, while applying a hydrogen pumping current across the membrane electrode assembly.

4. The method of claim 3, wherein the reactant gases comprise:
an oxygen source supplied to the first electrode side;
hydrogen gas supplied to the second electrode side; and
wherein the oxygen source supplied to the first electrode side combines with reformed hydrogen at the first electrode to produce water molecules which flush out remaining acidic solution on the first electrode side.

5. The method of claim 3, wherein supply of the reactant gases at relative humidity above saturation occurs at a cell temperature of less than 60° C.

6. The method of claim 3, wherein the reactant gases have a relative humidity value (RH) of at least 150% and the fuel cell or fuel cell stack is operated at a voltage of 500 mV or less.

7. The method of claim 1, further comprising:
providing dry reactant gases to the first electrode side and second electrode side after contaminants are removed.

8. The method of claim 1, further comprising:
introducing the acidic solution to the second electrode side and hydrogen gas to the first electrode side; and
applying a reversed hydrogen pumping current across the membrane electrode assembly;
wherein the contaminants are concentrated on the second electrode side, and
wherein the contaminants are removed from the second electrode side by contact with the acidic solution.

9. The method of claim 8, further comprising:
supplying reactant gases at relative humidity above saturation to the first electrode side and the second electrode side, while applying a hydrogen pumping current across the membrane electrode assembly.

10. The method of claim of 9, further comprising:
providing dry reactant gases to the first electrode side and second electrode side after contaminants are removed.

11. The method of claim 1, wherein contaminants are selected from the group consisting of cations of cobalt, nickel, calcium, sodium, potassium, magnesium, barium, aluminum, chromium, iron, or a combination thereof.

12. The method of claim 1, wherein the acidic solution is an aqueous acidic solution of about 0.05 M to about 1.0 M.

13. The method of claim 1, wherein the acidic solution comprises an acid selected from the group consisting of nitric acid, hydrochloric acid, sulfuric acid, hydrobromic acid, hydroiodic acid, perchloric acid, chloric acid, and/or a combination thereof.

14. The method of claim 1, wherein the acidic solution is supplied at a constant rate ranging from about 10 ml/min per cm³ to about 100 ml/min per cm³.

15. The method of claim 1, wherein the acidic solution has a temperature in the range of about 40° C. to about 100° C.

16. The method of claim 1, wherein the fuel cell or fuel cell stack remain assembled and/or in an original position during contaminant removal.

17. A method of removing contaminants from a polymer electrolyte membrane fuel cell or fuel cell stack, comprising:
introducing an acidic solution to a first electrode side and hydrogen gas to a second electrode side of a membrane electrode assembly and applying a hydrogen pumping current across the membrane electrode assembly;
introducing the acidic solution to a second electrode side and hydrogen gas to a first electrode side of the membrane electrode assembly and applying a reverse hydrogen pumping current across the membrane electrode assembly;
optionally removing remnant acidic solution from the first electrode side or second electrode side by supplying reactant gases at relative humidity above saturation to the first electrode side and second electrode side; and
optionally supplying dry reactant gases to the first electrode side and second electrode side.

18. The method of claim 17, wherein the acidic solution is an aqueous solution of about 0.05 M to about 1.0 M, and has a temperature of about 40° C. to about 100° C.

19. The method of claim 17, wherein removal of acidic solution comprises supplying the reactant gases at a relative humidity (RH) value of at least 150%.

20. A method of in-situ performance loss prevention for polymer electrolyte membrane fuel cell or fuel cell stack, comprising:
a) introducing an acidic solution to a cathode side of a membrane electrode assembly and hydrogen gas to a anode side of the membrane electrode assembly, and applying a hydrogen pumping current across the membrane electrode assembly;
b) supplying reactant gases at relative humidity above saturation to the cathode side and the anode side; and
c) providing dry reactant gases to the cathode side and anode after contaminants are removed;
d) optionally conducting steps a) through c) for an opposite side of the membrane electrode assembly, wherein in step a) the acidic solution is introduced to the anode side and the hydrogen to the cathode side, and a reversed hydrogen pumping current is applied across the membrane electrode assembly.
